(19) United States
(12) Patent Application Publication
(10) Pub. No.: US 2008/0156586 A1
(43) Pub. Date: Jul. 3, 2008

(54) Climbing Tree Stand

(75) Inventor: Jeffrey A. Pestrue, St. Louis, MI (US)

Correspondence Address: CARRIER BLACKMAN AND ASSOCIATES, 24101 NOVI ROAD, SUITE 100, NOVI, MI, 48375, US

(73) Assignee: EASTMAN OUTDOORS INC., Flushing, MI (US)

(21) Appl. No.: 11/965,189

(22) Filed: Dec. 27, 2007

Related U.S. Application Data
(60) Provisional application No. 60/877,468, filed on Dec. 28, 2006.

(51) Int. Cl. A01M 31/02; A63B 27/00

(52) U.S. Cl. 182/136

(57) ABSTRACT

A climbing tree stand according to the invention comprises a seat support assembly and a standing platform assembly. Each of the respective support assemblies has a pair of arms which are attached to a standing frame member and a main frame member. The arms are pivotally movable relative to the foot and main frame member, respectively. A flexible attachment is used to affix the arms to the platforms allowing the climbing tree stand to more easily climb trees that may not have ideal surface features or relatively consistent diameters. This allows the user of the climbing tree stand to have more options with respect to the type and size of tree used to climb and secure the tree stand. The flexible arms permit the tree stand to adjust slightly around obstacles on the trunk of the tree, such as limb stumps while alternately moving each assembly up the tree.

### CROSS REFERENCE TO RELATED APPLICATIONS

This application claims the benefit of U.S. Provisional application No. 60/877,468 filed 28 Dec. 2006.

### BACKGROUND OF THE INVENTION

1. Field of the Invention

The present invention relates to climbing tree stands such as those used by hunters and other outdoor enthusiasts. More particularly, the present invention relates to climbing tree stands with features for enabling a user to climb a tree that is irregular or tapered, with different trunk diameters at different levels of the tree. Generally, the diameter of most trees tapers going upward. This causes problems for most treestands that are set up close to the ground where the diameter of the tree is the greatest. In addition, safety of the user is very important since the tree stand most likely will be used at a height that could cause serious injury if there was a failure of the securement device employed by the tree stand causing the user to fall a great distance.

2. Description of the Background Art

When hunting for ground dwelling game, such as deer and the like, it is desirable for a hunter to avoid notice by his quarry. Towards this end, a hunter of such ground dwelling game will often seek to conceal himself from the normal field of perception of the game being sought. Normally a blind or a tree stand would be set up from which the hunter may wait undetected and observe and/or shoot the quarry or game.

Such a tree stand is often a portable structure or platform which is carried by the hunter into the woods, and is then set in place in an elevated position on the tree, for use during the hunting season. When the hunt is completed, or hunting season closed, the tree stand may then be removed from the tree and taken away. On public lands, it may be required that the tree stand be removed at the end of hunting season. The tree stand may, alternatively, remain in place for an entire hunting season, if desired and allowed.

Tree stands can be used for many purposes, and can also be used by non-hunters, such as photographers or naturalists, to observe game. The tree stand can be used when it is desirable to remain unseen or undetected by the game. Generally tree stands are used to elevate a user to a position above the ground. This can be beneficial for the user from the standpoint of line of sight or being able to see further from the tree stand. The elevation above the ground is also beneficial to the user since the scent of a user may be harder to detect by the game in the area. A further benefit to the tree stand user is that the user is elevated above the normal line of sight of the game, allowing the user to have some movement in the tree stand without the game noticing this movement. This could be especially important to the hunter or cameramen that have to move to complete a task, such as to draw an arrow or to move a camera to focus on a subject.

Many tree stands are fixed in place once they have been positioned in a tree, meaning that the user must determine the game movement lanes and, hopefully locate a suitable tree that allows the user good visibility while the game is within range of the gun, bow or camera. Often, such scouting and installation must be done prior to the start of a hunting season. This installation may require multiple trips to the location with equipment, such as a ladder, and may require multiple trips up the tree to secure a tree stand. Multiple trips to the location may result in the game in the area observing or smelling the presence of the user causing the game to change their daily patterns or travel routes. Then, the tree stand will need to be relocated to give the user the ability to view the desired game, causing multiple trips to a new location.

While range is not that important when hunting game with a rifle, especially modern high-powered rifles, range can be critical for hunting with a bow and arrow. Most hunters cannot carry a shot beyond 40 yards, and many will not take a shot beyond 20 yards. Of course, the distance the hunter can see and the thickness of the vegetation around the tree stand will affect the range of the hunter.

It is therefore beneficial to have a tree stand that can be relatively easily installed or located, and that can be removed and reinstalled at a different location, if necessary.

A climbing tree stand is a particular type of tree stand, which allows the user a secure seat support member around the trunk of the tree, and then secure a separate standing platform member around the trunk of the tree below the seat member. By alternating climbing with the seat support member and the standing platform member, the user can gradually climb the tree, while raising the components of the climbing by stages, to the desired elevation and location in the tree. This method of climbing of the tree requires that essentially all protruding tree limbs be removed from the area of the tree trunk which is to be climbed, and when using conventional climbing stands, the trunk of the tree needs to be relatively consistent in diameter. The removal of the tree limbs can, if improperly done, leave a stump that can be difficult to get the climbing tree stand over while climbing to the desired elevation.

It can be difficult to find a good game location having a tree that is relatively straight and has a consistent diameter with few surface challenges or imperfections, such as the stumps mentioned above.

The climbing of a tree by the hunter, the placing of the stand, and the subsequent wait on the stand, all take place at heights which represent a potential for injury should the hunter fall. It will be remembered that such activities usually take place in the isolation of the woods, far from medical help, and often, even far from first aid providers. Therefore, it is always recommended that a full body harness be used by the user, with the harness tethered to a tree strap, when operating from an elevated position in a tree stand or ladder stand.

A number of different devices are known for climbing trees. Examples of some of the known devices include U.S. Pat. No. 5,234,076 to Louk et al, and U.S. Pat. No. 5,921,348 to Louk et al.

Further examples of some of the known climbing stands include those described in U.S. Pat. No. 6,988,588 to Prejean, which discloses a climbing tree stand platform member, and jaws or blades that bite into the tree to hold each of the climbing members in place after the stand is located in the desired position on the tree. Each of the pivot arms has a generally triangular tree-contacting member rigidly connected thereto, which bites into the tree to prevent the pivot arms from slipping.

Another example of a known device comprising a climbing stand is described in U.S. Pat. No. 6,986,404 to Laborde, which discloses a climbing tree stand that provides upper and lower platforms that are independently movable up the tree by the user alternatively moving one or the other of the platforms. Each platform has a flexible chain that enables a user to adjust the length of the cable that extends from the platform to the tree. Other examples of known tree stands and climbing stands are described in U.S. Pat. No. 6,942,064, U.S. Pat. No. 6,866,120, and U.S. Pat. No. 6,959,786.

While many of the devices described in the above references will allow a user to climb a tree, they do not allow relatively easy climbing of a tree that may be tapered, leaning, have an inconsistent diameter, or have surface challenges from removed limbs or the such.

Although the climbing stands have some utility for their intended purposes, a need still exists in the art for an improved climbing tree stand. In particular, there is a need for an improved tree stand which will enable a user to climb tapered trees that are not necessarily straight, trees that are not consistent due to surface or bark imperfections, or those that are not symmetrical.

### BRIEF SUMMARY OF THE INVENTION

The invention described herein provides an adjustable climbing stand apparatus for use in climbing trees and for use in elevated observation or hunting.

Accordingly, it is an object if the invention to provide a method and climbing stand apparatus usable for climbing trees that may be tapered, irregular, have surface imperfections or challenges or have a relatively inconsistent diameter. It is a further object of the invention to provide a climbing tree stand that allows the user to climb trees that may be crooked.

A further object of the invention is to provide an easily adjustable tree stand that allows the user to climb trees that may taper in diameter as they increase in height.

Another object of the present invention is to provide a tree stand that is more adjustable than previously known tree stands, allowing the user to climb trees that may have surface challenges or inconsistencies.

Another object of the present invention is to provide a climbing tree stand that is easily transportable from location to location by a single person.

For a more complete understanding of the invention, the reader is referred to the following detailed description section, which should be read in conjunction with the accompanying drawings. Throughout the following detailed description and in the drawings, like numbers refer to like parts.

Accordingly, the it is an object of the invention to provide a portable tree stand with securing features for ensuring that it remains level and securely affixed to a tree or pole while in use. The upper and lower portions of the stand each feature a pivotally adjusting arm that may be rigidly fixed to a body panel of the respective portions, including a fixed frame, that allows for maneuvering the portions up and down the tree.

The standing platform assembly and the seat support assembly each include securing straps that may be attached to the pivotally adjusting arms that allow for the stand to be secured around the trunk of the tree. The standing platform assembly and the seat support assembly each further include serrated blades secured to an end of the stand adapted for placement contacting the tree trunk that allows the stand to be securely attached to the trunk of the tree. The standing platform assembly and the seat support assembly each also include a securing strap or chain, operatively affixed to the respective uppermost portions of the pivot arms, that allows for additional support to secure the tree stand to the trunk. The lower standing platform assembly portion of the stand also features foot straps or other similar structure, through which toe portions of a climber's footwear may be placed, to assist the user in raising the lower portion of the climbing stand. The foot straps or other similar structure may be affixed to the platform, or alternatively, may be attached to a rigid frame portion of the standing platform member.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

A preferred embodiment of the invention of a climbing tree stand and method of using it will be better understood when consideration is given to the detailed description of the accompanying drawings, wherein like elements bear like reference numerals and where:

FIG. 1 is a perspective view of a portion of a tree trunk with a climbing tree stand installed thereon according too a first illustrative embodiment of the invention, where the climbing tree stand includes a seat support assembly and a separate standing platform assembly.

FIG. 2 is a top plan view of the seat support assembly of the climbing tree stand shown in FIG. 1.

FIG. 3 is a top plan view of the standing platform assembly of the climbing tree stand shown in FIG. 1.

FIG. 4 is an exploded detail view of illustrative hardware which may be used for the interconnection of adjustment arms to the platform in each of the respective support assemblies.

FIG. 5 is a partial front view of one embodiment of the interconnection of the adjustment arms to the platform.

FIG. 6 is a sectional detail view of one embodiment of a flexible attachment or flexor usable as one component of the tree stand according to the invention.

FIG. 7 is a close up perspective view of the flexible connector affixed to the pivoting arms and shown around a tree.

FIG. 8 is a close up perspective view of the tree-securing claw affixed to the illustrated embodiment of the invention.

FIG. 9 is a close up perspective view of the bootstraps affixed to a pivoting arm of the illustrative embodiment of the invention.

FIG. 10 is a perspective view of the lower portion of the illustrated embodiment of the invention with the bootstraps and flexible connector affixed to the pivoting arms.

### DETAILED DESCRIPTION OF THE ILLUSTRATIVE EMBODIMENT

It should be understood that only structures considered necessary for clarifying the present invention of a climbing tree stand are described herein. Other conventional structures, and those of ancillary and auxiliary components of the system, are assumed to be known and understood by those skilled in the art

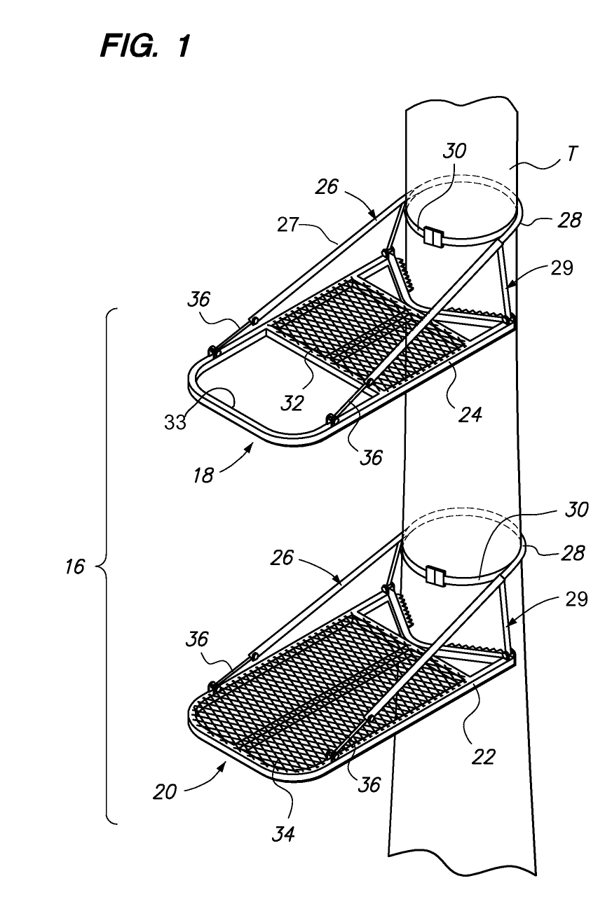

Referring now to the drawings, FIG. 1 is a perspective cutaway view of a tree T having a climbing tree stand 16, according to a first illustrative embodiment of the invention, installed thereon. The climbing tree stand 16 is a generally two-piece unit having a seat support assembly 18 and a separate standing platform assembly 20 which are each independently affixed to the tree T and which are vertically spaced apart from one another. The two assemblies 18 and 20 cooperate to define the climbing tree stand 16. The only physical connection between the two assemblies 16, 18 is provided by the user while climbing the tree. However, for safety, it is strongly recommended that a tether (not shown) attach the two assemblies together. This is in case the standing platform assembly 20 would become detached from the tree while the hunter is sitting on the seat support assembly 18, assembly 20 will not fall to the ground leaving the user stranded in the tree. If the two assemblies 18, 20 are tethered, the hunter or user would be able to reposition the assembly 20 on the tree and return to the ground safely. In addition, for safety, it is highly recommended that the user of the climbing tree stand 16 use a full body safety harness and that the user remain harnessed to the tree from the moment the user leaves the ground until the user returns to the ground.

It should also be noted that the assemblies 18, 20 may be secured together in a collapsed condition for transportation to and from the hunting/observation area. It will be necessary to transport the climbing tree stand 16 from a user's storage location to the desired location to hunt or observe game. A compact kit of components makes transportation in a vehicle and by an individual much easier. The pivot arms 26 fold from a storage or non-use position to an upright or climbing position. When folded, the two assemblies 18, 20 comprise a relatively flat kit (not shown) that can be carried on the users back in a manner similar to a backpack, utilizing shoulder straps (not shown). The shoulder straps are of the type well known for use in carrying backpacks and would be detachable from the kit. The assemblies 18, 20 would form a kit when secured together with a rope, bungee cord, or other securement device that would hold the assemblies 18, 20 together so that there was very little movement between the two assemblies 18, 20.

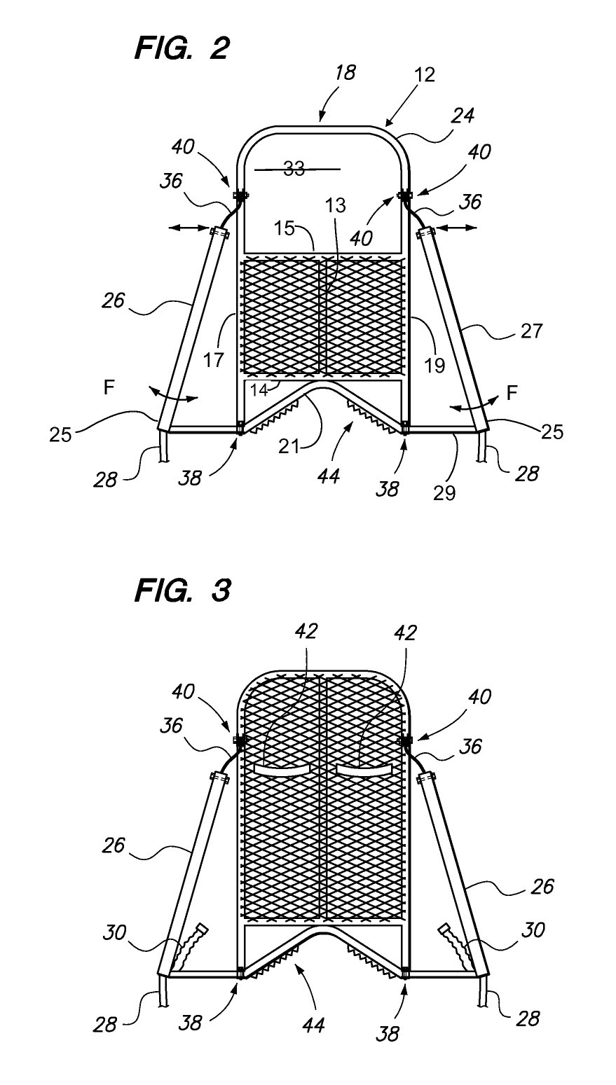

The two assemblies and their differences can best be seen in FIG. 2 and FIG. 3. The seat support assembly 18 is shown as the top assembly in FIG. 1 and as a plan view in FIG. 2. The seat support assembly 18 includes a seat frame 12, a platform grid 32 attached to the top of the seat frame, a pair of generally L-shaped pivot arms 26 attached to opposite sides of the seat frame, and a flexible support band 28 for interconnecting the pivot arms, and for wrapping around behind a tree T to anchor the assembly in place thereon. Each of these parts will be described in further detail below.

In the first embodiment, as seen in FIGS. 1 and 2, the seat frame 12 comprises a generally U-shaped main frame member 24 with parallel arm portions 17 and 19, a first crossbar 14 extending between the free ends of the parallel arm portions 17, 19 and a generally V-shaped tree-contacting gripper bar 21 extending between the free ends of the main frame member adjacent the first crossbar, for placement against the tree T. This gripper bar may include teeth 44. The seat frame may, optionally, include a second crossbar 15 extending between the pivot arms 17, 19 of the main frame member 24, at a medial portion thereof, and may also include a reinforcement bar 13 extending between the first and second crossbars 14, 15 and running parallel to the arms 17, 19 of the main frame member, to help support the weight of a user seated on the support assembly 18.

The pivot arms 26 are each pivotally attached to the main frame member 24, with one pivot arm 26 located on each side of the main frame member, as shown in FIG. 2. The inner ends of the pivot arms 26 are, respectively, pivotally attached to the main frame member 24 with a pivot connection 38, and the outer ends of the pivot arms are flexibly attached to the main frame member 24 with an adjustably movable connection 36. The arrows F shown in FIG. 2 illustrate the flex motion the connections 38 and 36 allow the pivot arms to make. This motion permits the tree stand 16 to flex the pivot arms 26 around obstacles on the tree trunk. Each of the pivot arms 26 are substantially V-shaped, including a main support section 27, and a short connection section 29 which intersects and joins with the main support section at an elbow-shaped corner joint 25. The adjustably movable connection 36 at the outer end of each arm 26 may be a flexor 37 as subsequently described herein, or alternatively, may be a second pivot connection similar to the pivot connection 38 at the inner end of the pivot arm 26.

The platform grid 32 is placed on top of the seat frame 12 and attached to and extending across the mainframe member 24 such that the grid 32 can support the weight of a user seated thereon. The platform grid 32 may be formed from interlaced strips of woven fabric material, leather or alternatively, may be made of strong metal paneling or metal screen mesh material. Weight is an important consideration when selecting the type of material for platform grid 32 since the climbing tree stand 16 will need to be moved to a remote location. The platform grid 32 should be sufficiently strong enough to support the weight of a user and accompanying equipment thereon. The platform grid 32 is made in a size which does not entirely fill the main frame member 24, but rather leaves an opening 33 between the frame member 24, to allow a user to extend his or her legs therethrough when seated on the grid, or when standing on the platform assembly 20. This opening 33 is best seen in FIG. 2. The location of the opening is advantageous in that it permits the user to have leverage while climbing the tree with the tree stand 16 and also allows the user to sit on the grid 32 with their back to the tree. Alternatively, the seat portion may comprises a mesh (not shown) loosely strung on the frame 12 such that the mesh can be moved to one end of the frame to be out of the way of the user while climbing the tree stand 16. Then when the tree stand 16 is secured in the tree, the mesh or netting would be spread along the frame 24 to form the desired seat or support.

The standing platform assembly 20 comprises a U-shaped base frame member 22, which is similar in size and shape to the main frame member 24. Constructed to be similar in size and shape to the seat support assembly 18 the standing platform assembly includes a U-shaped main frame member 24 and a crossbar 14 extending between the free ends of the main frame member 24. The standing platform assembly 20 also includes a generally V-shaped tree-contacting gripper bar 16 extending between the ends of the main frame member 24 adjacent the crossbar, for placement against the tree T. The gripper bar 21 may include teeth similar to the gripper bar on the seat support assembly 18. The standing platform assembly 20 also includes a pair of pivot arms 26, pivotally attached to the main frame member 24 at an inner end of the pivot arms 26, and also attached to an outer portion of the main frame member at the other end with a flexor 36, 37.

The pivot arms 26 each have a cable 28 adjustably affixed between outer ends of the main support sections 27, in order to secure the seat support assembly 18 and the standing platform assembly 20 to the tree T as the device is moved up and down the tree T. Unlike the support assembly 18 and the seat defined thereon by the grid 32, the standing platform assembly 20 has a foot rest 34 extending across the top of the main frame member 24 and formed of a strong, rigid, yet foraminous material. Again, weight and strength are important considerations when the material for the grid 34 is being chosen.

As discussed previously, FIG. 2 shows the seat support assembly 18 and the attachment of the pivot arms 26 to the main frame member 24. A rotating attachment 38 secures the pivot arms 26 to the main frame member 24 at one end and a flexible attachment 40 and flexor 36, 37 secures the other end of the pivot arms 26 to the other end of the main frame member 24.

FIG. 3 shows the standing platform assembly 20 and the attachment of the pivot arms 26 to the base frame member 22. A pivot attachment 38 secures the inner ends of the short connection sections 29 to the base frame member 22 at one end of the pivot arms and a flexible attachment 40 including a flexor 36 secures the outer end of the pivot arms 26 to the outer end of base frame member 22.

The pivot attachment 38 provides a pivotal freedom of movement of the connective sections 29 of pivot arms 26, relative to the base frame member 22 and the main frame member 24, respectively, in the flexible attachment 40, at the outer ends of the pivot arms 26, provides both a rotating movement and a translation of the pivot arms 26 relative to both the base frame member 22 and the main frame member 24. This can provide a significant advantage when climbing with the tree stand 16, in that the pivot arms 26 are not purely restricted to a rotational movement relative to both the foot and main frame member 22, 24, but the pivot arms 26 can also translate enough to overcome most non-uniformities in the trunk of the tree T when climbing. The pivot arms 26 do not have to be moved together, but can also be independently rotated and translated. This allows the user of the tree stand 16 to climb trees T that may not be exactly straight, may have some trunk imperfections and may not have a relatively uniform diameter. This pivotal movement of the pivot arms 26 also allows adjustment of the stand 16 to fit in wider or narrower portions of a tapered tree.

Both the main frame member 24 and the base frame member 22 have a securing surface 44 that interfaces with the tree T, provided by the teeth or other texture on the gripper bar 21.

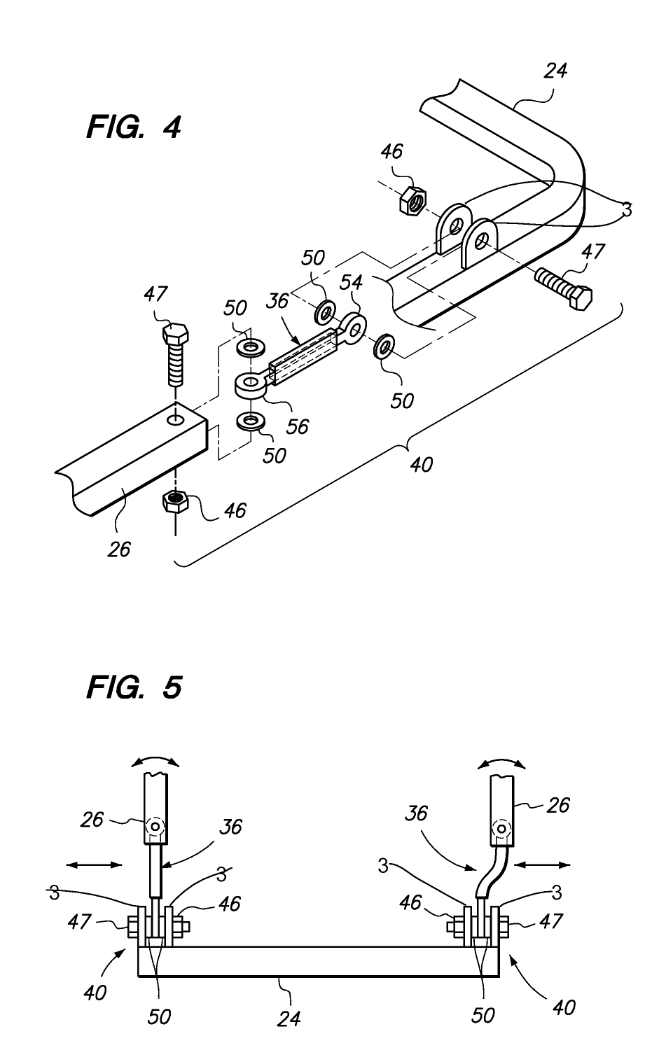

FIG. 4 shows an exploded view of the attachment of the pivot arm 26 to the main frame member 24 with flexible attachment 40 and flexor 36. The first eye 54 of the flexor 36 is secured between two bosses 3 on the main frame member 24. A pair of washers 50 are located on either side of the first eye 54 and the bolt 47 is placed through the boss 3, washer 50, eye 54, washer 50, second boss 3 and secured with nut 46. The second eye 56 is sandwiched by a pair of washers 50 and inserted into the end of the pivot arm26 and secured by bolt 47 and nut 46, best seen in FIG. 4. The other flexible attachments 40 are connected in like manner to both the main frame member 24 and the base frame member 22.

FIG. 5 shows a view of the flexible attachment 40 and flexor 36 securing the pivot arms 26 to the main frame member 24. The pivot arms 26 are attached to the base frame member 22 in like manner.

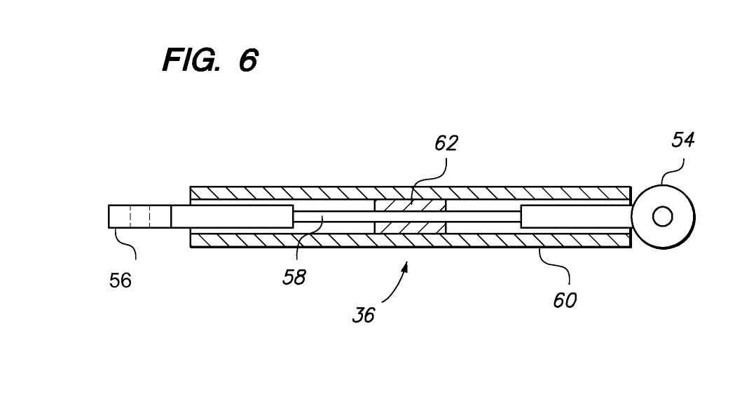

FIG. 6 shows a cutaway view of the flexor 36 including the first eye 54 at one end and the second eye 56 on the second end. The eyes 54, 56 are crimped to cable 58, best seen in FIG. 6. A tube of flexible material is affixed approximately midway between the eyes 54,56 and the assembly is covered by a sleeve 60 as shown. Note that the eyes 54, 56 are attached to cable 58 rotated 90 degrees, for strength and flexibility in the connection.

To use the climbing tree stand 16, the user would wrap cable 28 around the tree T at a comfortable height and secure with fasteners 70 to the pivot arms 26. The seat support assembly 18 is thus secured to the tree T at a height comfortable with the user standing on the ground. The standing platform assembly 20 is then placed nearer the ground and the cable 28 is wrapped around the tree T and secured to the pivot arms 26 with fasteners 70.

The user then steps onto the foot rest 34 and secures the feet beneath the foot straps 42, and insert their body between the seat 32 and front of the seat support assembly 18. The user grasps and rotates each of the pivot arms 26 to pull the securing surface 44 away from the tree T. The user then lifts and rotates the pivot arms 26 to elevate the seat support assembly 18 higher up the tree T. The securing surface 44 is then located against the tree T at a new higher position.

Once the seat support assembly 18 is secured, the user then lifts the feet and moves the pivot arms 26 if necessary, such that the securing surface 44 of the standing platform assembly 20 is moved from the tree T. The user then lifts the standing platform assembly up the tree. It may be necessary to rotate the pivot arms 26 when lifting. When standing platform assembly 20 is located at a comfortable position, the securing surface 44 is placed against the tree T. The standing platform assembly 20 is then secured at that elevation. The user continues this movement of the seat support assembly 18 and the standing platform assembly 20 until the desired circumferential location and elevation in tree T have been obtained. Once this desired location is obtained, the straps 30 of the seat support assembly 18 and standing platform assembly 20, respectively, are connected and tightened to help secure the tree stand 16 to the tree T. The user can then use the tree stand 16 as desired either viewing or hunting game. As one can imagine, the tree T most likely does not have the appearance of a telephone pole. Having the flexors 36 attached to the pivot arms 26 allows the user to work the seat support assembly 18 and standing platform assembly 20 to the correct position in the tree T. The flexors 36 allow the user to move the pivot arms 26 of the mainframe member 24 and base frame 22 around any obstacles that may be encountered on the surface of the tree T.

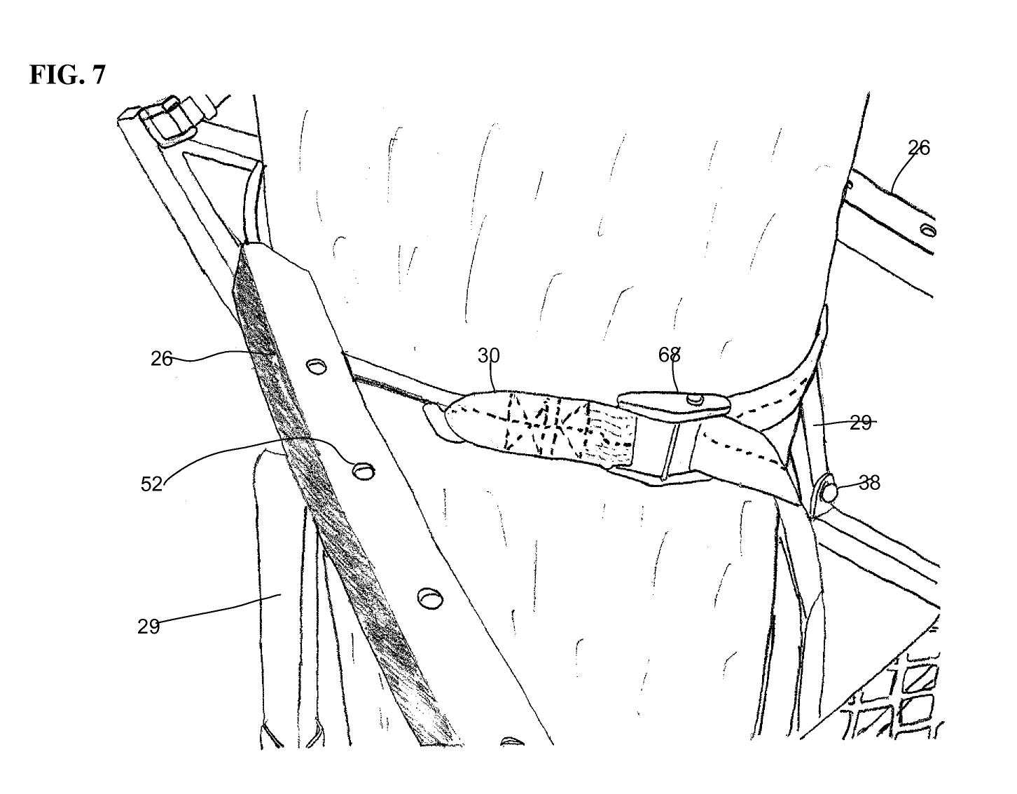

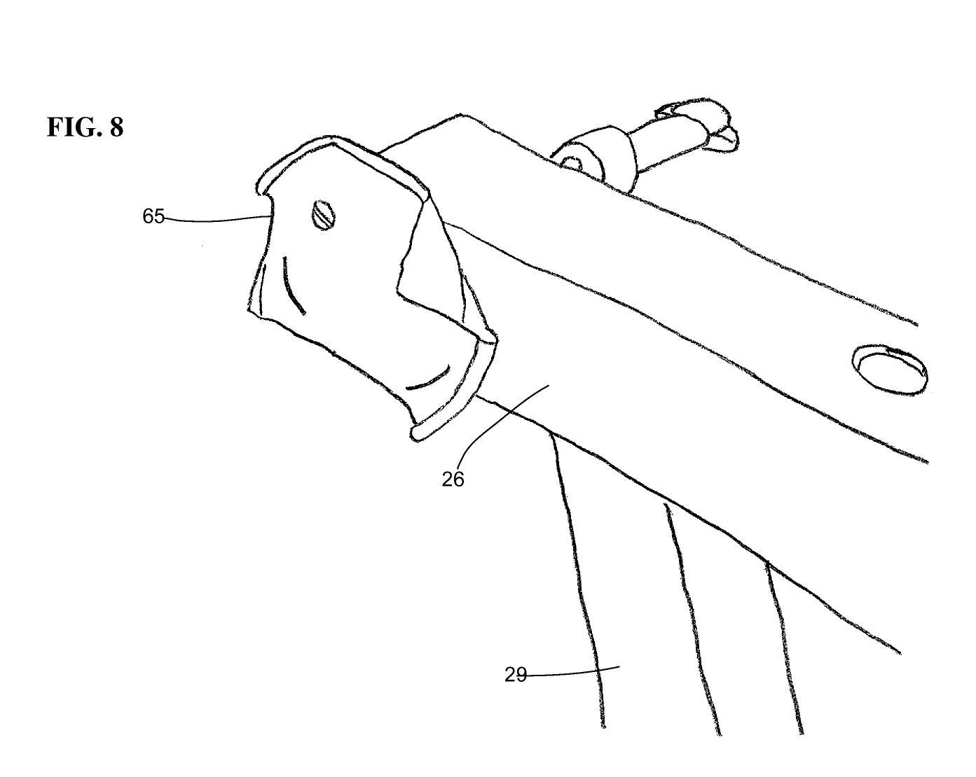

FIG. 7 illustrates the platform retainer strap 30 which is secured around the tree when the user reaches the desired height in the tree. The cam buckle 68 is used to secure the strap 30 and tighten it to securely hold the assembly, 18 or 20 in the tree. The cam buckle 68 is well known in the art. The adjustment holes 52 for adjusting the length of the flexible support band 28 can also be seen on the pivot arms 26 in FIG. 7. In order to select the proper adjustment hole 52, the narrowing or taper of the tree must be taken into consideration. To compensate for this taper, each assembly 18, 20 must be tilted such that the portion adjacent the tree is lower than the outer potion. As the tree stand 16 is moved up the tree trunk, the outer edge of assemblies 18, 20 will move down, as the taper of the trunk gets narrower. This angle must be determined on the ground since the tree stand 16 should not be adjusted while in the tree T.

FIG. 8 shows the claw 65 provided at the end of pivot arm 26. Claw 65 is adapted to engage the side of the tree.

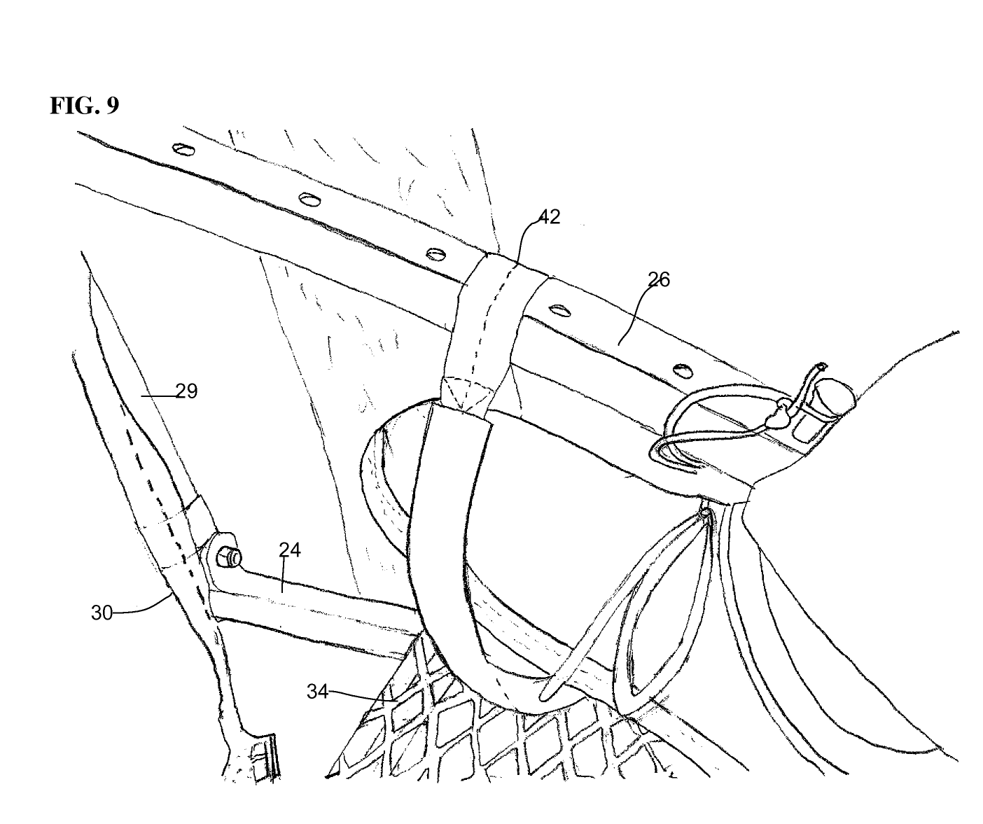

FIG. 9 shows a partial view of the standing assembly 20 and a variation of the boot straps 42 adapted to engage and secure the user's feet to the platform grid 34. The boot straps 42 secured between the pivot arm 26 and the platform grid 34 instead of the arrangement of the straps 42 as shown in FIG. 3.

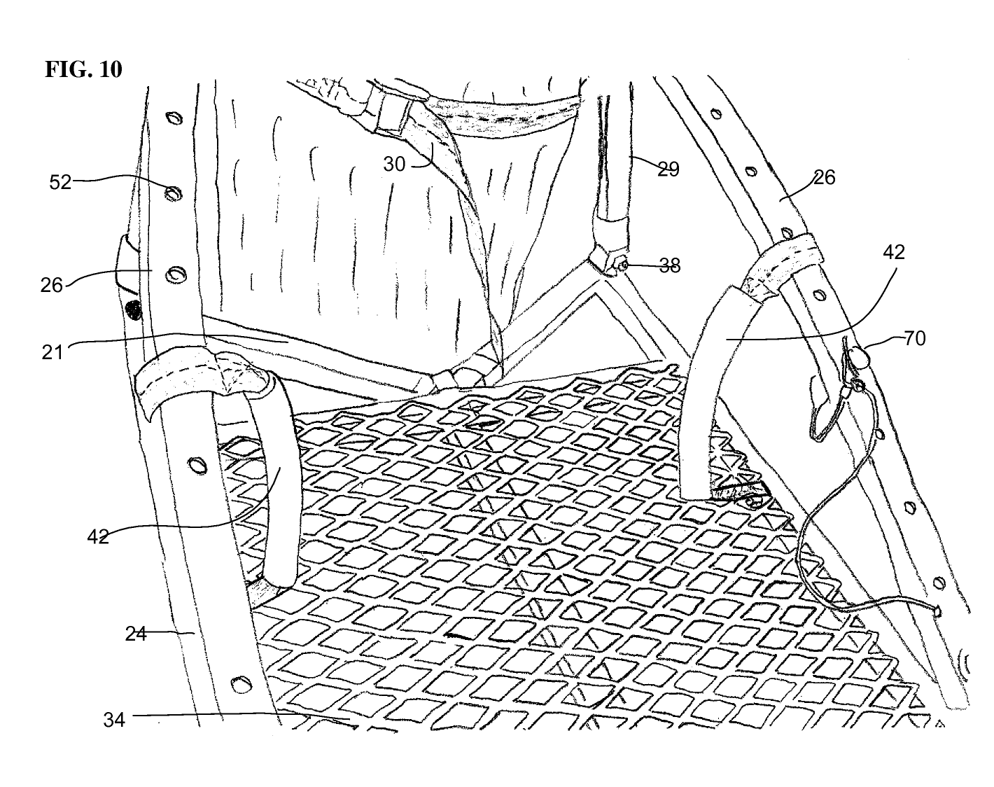

FIG. 10 shows a partial view of the standing platform assembly 20 including grid 32, pivot arms 26 and adjustment holes 52. A connector 70 is seen in an adjustable hole securing the flexible support band 28. The connector 70 comprises a D-ring snap pin on a tether. The gripper bar 21 is against the tree T and platform retainer strap 30 is engaged and tightened around the trunk to secure the portion of the tree stand 16 in place.

Although the present invention has been described herein with respect to a number of specific illustrative embodiments, the foregoing description is intended to illustrate, rather than to limit the invention. Those skilled in the art will realize that many modifications of the preferred embodiment could be made which would be operable. All such modifications, which are within the scope of the present disclosure, are intended to be within the scope and spirit of the present invention.

What is claimed is:

1. A climbing tree stand for use in climbing a tree and for supporting a user at an elevated position in the tree, the tree stand comprising a seat support assembly and a standing platform assembly,
said seat support assembly comprising:
a substantially U-shaped main frame member;
a pair of seat arms, with a pivot attachment securing a first end of the respective seat arms to the main frame member, and an adjustably movable attachment securing a second end of each of the respective seat arms to the main frame member;
a first cable for adjustably affixing to and interconnecting said seat arms and for placement extending around said tree;
a flexible support surface attached to the main frame member;
a strap affixed to each seat arm;
a seat attached to the main frame member;
said standing platform assembly comprising:
a U-shaped standing frame member;
a pair of standing platform arms, with a pivot attachment securing one end of each of the respective standing platform arms to the standing frame member, and a flexible attachment securing a second end of each of the respective standing platform arms to the standing frame member;
a second cable for adjustably affixing to and interconnecting said seat arms and for placement extending around said tree;
a securing surface attached to the standing frame member;
a strap affixed to each standing platform arm; and
a foot rest attached to the standing frame member.

2. The tree stand of claim 1, wherein each of the seat arms and standing platform arms comprises a rigid extension formed from hollow tubing and having a plurality of through holes formed therethrough to receive an adjustment pin; and
a rigid riser tube affixed to the extension and cooperating therewith to define an acute angle therebetween.

3. The tree stand of claim 1, wherein the flexible attachment comprises:
a flexor, one end of the flexor attached to the arm and the second end of the flexor attached to the platform;
the flexor having a first eye on one end attached to a cable and a second eye attached to the second end of the cable;
a pair of washers for securing to each side of the eyes;
a tube circumscribing the cable, the tube located approximately midway between the first eye and the second eye; and
a sleeve, the sleeve encasing a portion of the eyes, the cable and the tube.

4. The tree stand of claim 1, wherein said strap affixed to each arm of said standing frame and said main frame adapted to be tightened around the trunk of a tree to secure the tree stand in the tree.

5. The tree stand of claim 1, wherein said securing surfaces include teeth thereon for engaging the tree trunk.

6. The tree stand of claim 1, wherein said foot rest includes straps for securely holding at least one foot.

7. The tree stand of claim 1, wherein each said arms include a claw to securely attach said tree stand to the tree and said strap adapted to be tightened to pull said arms inward to engage said claw onto the tree.

8. The tree stand of claim 1, wherein said pair of seat arms and said pair of standing platform arms are pivotally and adjustably movably attached to said main frame member at spaced locations such that said arms flex to allow said tree stand to adjust to obstacles on the tree trunk.

9. The tree stand of claim 1, wherein said seat arms are adjustably movably attached to said main frame at a first end thereof and attached to said main frame at a second end by a connector, said connector attached to said main frame by a pivotal connection and said standing platform arms are adjustably movably attached to said standing frame member at first end thereof and attached to said standing frame member at a second end by a connector, said connector attached to said standing frame member by a pivotal connection.

10. A climbing tree stand for climbing and location in a tree, the tree stand comprising:
a seat assembly, the seat assembly having a U-shaped main frame member;
a pair of arms, one arm attached to each side of the main frame member;
a rotatable attachment, the rotatable attachment affixing one end of each arm to the main frame member;
a flexible attachment, the flexible attachment affixing a second end of each arm to the main frame member;
a securing surface provided for contacting a tree;
a cable, the cable removably attached to each arm and wrapping around the tree;
a strap, the strap attached to each arm for securing the seat assembly to the tree at the desired location;
a seat attached to the main frame member;
a standing platform assembly, the standing platform assembly having a U-shaped standing frame member;
a pair of arms, one arm attached to each side of the standing frame member;
a rotatable attachment, the rotatable attachment affixing one end of each arm to the standing frame member;
a flexible attachment, the flexible attachment affixing a second end of each arm to the standing frame member;
a securing surface, the securing surface for contacting the tree;
a cable, the cable removably attached to each arm and wrapping around the tree;
a strap, the strap attached to each arm for securing the standing platform assembly to the tree at the desired location;
the flexible attachment comprising a flexor, the flexor having a first eye on one end and a second eye on the second end;
the first eye and second eye connected to a cable;
a tube located on the cable and located between the first eye and the second eye;
a sleeve, the sleeve partially covering the first and second eye, the cable and the tube;
a pair of washers for installation on each side of the first and second eye; and
a nut and bolt for penetrating the washers and eyes and attachment to the arm and the platform.

11. The tree stand of claim 10, wherein said securing surface includes a series of teeth for contacting and attaching said tree stand to the tree.

12. The tree stand of claim 10, wherein each said strap is adapted to be tightened to pull said arms inward toward the tree to secure said tree stand to the tree.

13. The tree stand of claim 10, wherein said standing platform assembly includes at least one foot retainer.

14. The tree stand of claim 10, wherein each said arm includes a claw at one end that secures the tree stand to the tree when each said strap is secured and tightened to the tree.

15. The tree stand of claim 10, wherein each of the seat arms and standing platform arms comprises a rigid extension formed from hollow tubing and having a plurality of through holes formed therethrough to receive an adjustment pin; and
a rigid riser tube affixed to the extension and cooperating therewith to define an acute angle therebetween.
